(19) United States
(12) Patent Application Publication
(10) Pub. No.: US 2007/0074350 A1
(43) Pub. Date: Apr. 5, 2007

(54) Multi-purpose tool

(76) Inventor: Christian Dreps, Ravensburg (DE)

Correspondence Address: ROBERT W. BECKER & ASSOCIATES, 707 HIGHWAY 333, SUITE B, TIJERAS, NM, 87059-7507, US

(21) Appl. No.: 11/249,058

(22) Filed: Oct. 12, 2005

(30) Foreign Application Priority Data
Sep. 30, 2005 (DE) 20 2005 015 451.2

(51) Int. Cl. B25F 1/00; B26B 11/00; B25B 15/00; B25B 13/00

(52) U.S. Cl. 7/158; 7/165; 7/138

(57) ABSTRACT

A multi-purpose tool comprising a screw sleeve for receiving a screw or wrench bit, and a drill bit sequentially composed of a bit section, a torque-transmitting section, and a bit shaft that is adapted to be received in a drill. The torque-transmitting section and the bit section are adapted to be received in the screw sleeve in a form-fitting and torque-fast manner. The bit shaft is provided with three rotational drive surfaces that are disposed at an angle of 120° relative to one another and are adapted for rotational entrainment in a three-jaw chuck of the drill.

The invention relates to a multi-purpose tool pursuant to the introductory portion of claim 1.

Multi-purpose tools have been known for a long time. For example, DE-OS 28 17 721 shows a multi-purpose tool where a drill bit or a screw bit can alternatively be inserted into a screw sleeve.

DE-OS 30 09 592 and DE-PS 30 08 394 disclose a conical receiving means for a similar multi-purpose tool, with which, however, a special tool receiving means having an inner cone and a transverse opening are required for the ejection of the cone. Such a transverse opening is generally not provided with drills, so that this approach is not suitable for special drills.

Furthermore, a corresponding multi-purpose tool has been known for a long time that has a so-called SDS shaft that is provided with two oppositely disposed rotational drive grooves, and two locking grooves that are offset thereto by 90°. This tool can be driven only in special drills, in particular not in drills that are multi-functionally embodied as a battery-powered tool. However, it is just such drills that are particularly expedient for a screwing function, since they typically have a slip clutch and a sensitive speed control, as required for screwing.

In contrast, it is an object of the invention to provide a multi-purpose tool pursuant to the introductory portion of claim 1 that is particularly suitable for use in conjunction with high-power battery operated screwdrivers.

This object is inventively realized by claim 1. Advantageous further developments are found in the dependent claims.

Pursuant to the invention, three rotational drive surfaces are provided on the bit shaft that extend at an angle of 120° relative to one another. Such drill bits, and the multi-purpose tools thus formed by combination with the screw sleeve, not only fit well into the inventive high-power battery-operated screwdriver having the typical three-jaw chuck, but also are particularly suitable for the transfer of high rotational drive forces.

By providing rotational drive surfaces instead of the typical round shaft of drill bits generally used in a high-power battery operated screwdriver, a considerably greater torque can be transmitted during the screwing process, so that such battery-powered screwdrivers are also and particularly suitable for the setting of bed screws.

The inventive configuration of the multi-purpose tool surprisingly also opens the possibility of additional use of torque-transmitting aids. For example, a standard open end wrench having a suitable nominal value can be used with the provision of the inventive bit shaft having at least two rotational drive surfaces, which do not necessarily have to be flat, and which extend parallel to one another, so that pursuant to the present invention it is possible to continue the screwing process if the force of the battery-powered screwdriver is not sufficient, or for example the battery is discharged, and is only necessary to tighten the last screw. This is particularly advantageous since the workman or do-it-yourselfer that is using the battery-powered screwdriver, ordinarily finds it particularly inconvenient if the screwing force or the setting and tightening of the last screw is suddenly no longer adequate, whereupon they generally have to use a replacement battery or even have to recharge the present battery.

The charged state of the battery just before its depletion is typically readily adequate for undertaking drilling or starting to screw the screw in, whereas the full tightening requires the greatest force and hence typically overstrains the battery.

The invention is not limited to the provision of flat rotational drive surfaces on the bit shaft. Rather it is particularly expedient to also use grooved or concave rotational drive surfaces that reliably prevent slipping of the chuck even when the chuck is only tightened by hand. The radius of the grooves preferably amounts to the shaft diameter, but can also, for example, be reduced to the shaft radius.

Such hollow groove rotational drive surfaces can, with an appropriate configuration, be readily actuated by open end wrenches, whereby it is to be understood that in this connection it is expedient for the transitions at each end of the hollow groove rotational drive surfaces, when viewed in section through the bit shaft, to be provided with small radii, in other words not to taper to a point.

In any case, pursuant to the invention it is particularly expedient that a torque suitable for high-powered screwdrivers be capable of being transmitted not only during drilling but also during a screwing process, without the necessity for a special chuck.

The inventive drill bit is also particularly easy to manufacture, either from a round steel, in which case the rotational drive surfaces and the torque-transmitting section as well as the bit section are respectively milled or turned, or alternatively from an extruded hexagonal component that already from the start has suitable rotational drive surfaces.

It is particularly expedient for the shaft to have six rotational drive surfaces, and for the rotational drive surfaces, when viewed in cross-section, to have radial symmetry relative to one another.

It is particularly expedient for the shaft to have at least two rotational drive surfaces that extend parallel to one another and are disposed across from one another, and which are suitable for rotational entrainment via an open end wrench.

It is particularly expedient if three or six rotational drive surfaces, which when viewed in cross-section are radially symmetrical to one another, are each flat.

It is particularly expedient if, when viewed in cross-section, the rotational drive surfaces are concave.

It is particularly expedient for the drill bit to be produced from round steel, and for outer surfaces of the shaft or circular segment surfaces that complement the rotational drive surfaces in the periphery to each form arcs that are congruent to one another.

It is particularly expedient if the rotational drive surfaces each extend in the extension of force-transmitting surfaces of the torque-transmitting section.

It is particularly expedient for the screw bit receiving means to have a hexagonal recess, and for the torque-transmitting section to have a hexagonal surface, whereby the diameter of the torque-transmitting section is different from the diameter of the screw bit receiving means, and in particular is greater than the latter.

It is particularly expedient if the diameter of the torque-transmitting section is the same as the diameter of the screw bit receiving means.

It is particularly expedient for the torque-transmitting section to have a groove that is configured for receiving an in particular spring-loaded insertion securing means.

It is particularly expedient if a groove for receiving an insertion securing means on the torque-transmitting section has a concave base.

It is particularly expedient if a groove for receiving an insertion securing means on the torque-transmitting section has a flat base.

Further advantages, details and features are provided in the following description of several embodiments with the aid of the drawing, in which:

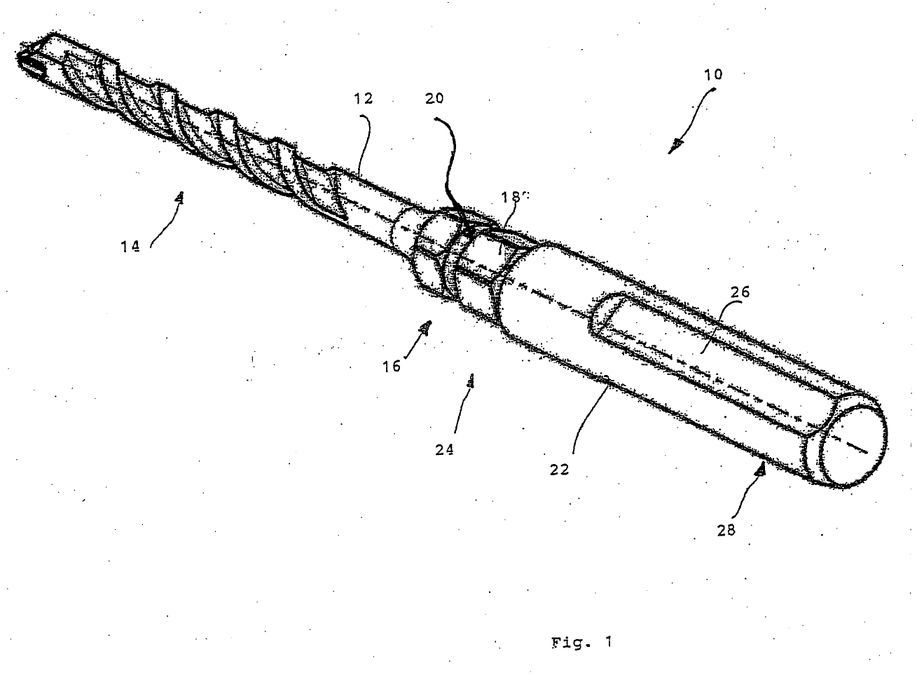

FIG. 1 shows a perspective view of an inventive multi-purpose tool, with the screw sleeve being omitted;

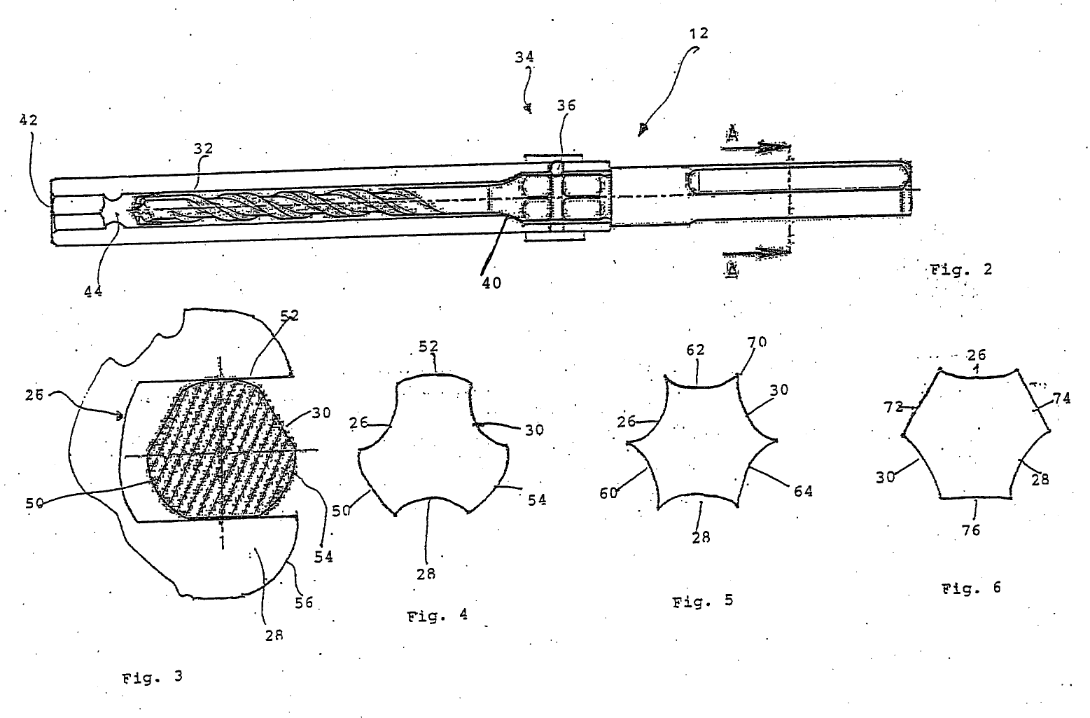

FIG. 2 shows a partially sectioned side view of the inventive multi-purpose tool;

FIG. 3 is a cross-section through the embodiment of FIG. 2 taken along the line of A-A;

FIG. 4 is a cross-section through another embodiment of the bit shaft of FIG. 3;

FIG. 5 is a cross-section through another embodiment of the bit shaft of FIG. 4; and

FIG. 6 is a cross-section through another embodiment of FIG. 5.

The inventive multi-purpose tool 10 is shown in FIG. 1 in a perspective illustration. A drill bit 12 is provided with a bit section 14 which is adjoined by a torque-transmitting section 16. The torque-transmitting section is provided with a hexagonal member 18, which has a length of about three times the diameter of the bit—viewed in the bit section 14—and is divided, viewed over its length, by a groove 20. The groove 20 is intended for receiving one or more balls of an insertion securing means of the screw sleeve, which can be seen in FIG. 2.

Following the torque-transmitting section 16 extends the bit shaft 22, with the transition being formed by a further groove 24. The bit shaft 22 has three rotational drive surfaces 26, 28 and 30, which when viewed in section extend symmetrically relative to one another, whereby the drive surfaces are better visible in FIG. 3. They extend over nearly the entire length of the bit shaft 22, and are disposed at an angle of 120° relative to one another.

In the illustrated embodiment, the bit is made of round steel, so that the remainder of the bit shaft is circular, and the rotational drive surfaces 26 have the character of circular segments. This also ensures that a good rotational drive can be realized in a three-jaw chuck.

FIG. 2 shows how the bit 12 can be accommodated in a screw sleeve 32. The bit section 14 is introduced entirely therein. An insertion securing means 34 is provided with a resiliently inwardly pre-tensioned ball 36 that engages in the groove 20. The transmission of force in the axial direction between the screw sleeve 32 and the bit 12 is effected by means of inclined surfaces 40, which can also be slightly concavely curved, as can be seen from FIG. 2, and which conform to or match corresponding inclined surfaces on the inner surface of the screw sleeve 32.

On its front end, the screw sleeve 32, in a known manner, is provided with a hexagonal recess 42 that, via axial supports 44, and possibly an insertion securing means similar to the insertion securing means 34 additionally provided at that location, is suitable for receiving a screw or wrench bit. It is to be understood that the diameter and the shape of the hexagonal recess 42 is adapted to conventional sizes; for example, a ¼ inch, a ⅜ inch, or a ½ inch receiving means can be provided. In the illustrated embodiment, the torque-transmitting section 16 is of a ⅜ inch size and the hexagonal recess 42 is of a ¼ inch size. It is to be understood that in place thereof it is readily possible for both to be of the same size or to provide other appropriate dimensions.

Various possible shapes for the inventive shaft configuration are illustrated in section in FIGS. 3 to 6. Instead of these, an entirely symmetrical hexagonal shape can also be used that can also have the same diameter as the torque-transmitting section, or can also have any desired greater diameter.

A further possibility is an entirely trihedral shape, possibly with rounded corners, which inventively enables the same rotational drive.

From FIG. 3 it can be seen that in a first embodiment circular segment surfaces 50, 52 and 54 alternate with the rotational drive surfaces 26, 28 and 30. Pursuant to the invention, here a size for nominal opening widths of open end wrenches is provided, whereby the use of an open end wrench 56 is schematically indicated in FIG. 3. In this case, the rotational drive is effected by the rotational drive surface 28, whereby merely a counter pressure is exerted by the circular segment surface 52. It is to be understood that with this embodiment an exact fit to the nominal value of the opening width is desirable.

A better support of the rotational drive by the open end wrench 58 can be realized with the embodiments of FIGS. 5 and 6.

FIG. 4 first of all shows the realization of the rotational drive surfaces 26, 28 and 30 by concave channels, which again alternate with the circular segment surfaces 50, 52 and 54. In contrast, with the embodiment of FIG. 5, fundamentally six rotational drive surfaces that are symmetrical to one another are provided, in other words, in addition to the rotational drive surfaces 26, 28 and 30, identical drive surfaces 60, 62 and 64 are provided that are symmetrical thereto and to one another.

It is to be understood that instead of the transitions 70 between the rotational drive surfaces that taper to a point as in FIG. 6, rounded transitions can also be provided in order to make handling of the bit easier.

A further modified embodiment of an inventive bit is provided in FIG. 6. With this embodiment, the three rotational drive surfaces 26, 28 and 30 are concave, and are respectively separated from one another by flat surfaces 72, 74 and 76.

This approach makes it possible, where a particularly high torque transfer is required, to place the jaws of the 3-jaw chuck of the drill against the rotational drive surfaces 26, 28 and 30, while where a low force is required, the flat surfaces 72 to 76 can also be used for the rotational drive.

1-13. (canceled)

14. A multi-purpose tool, comprising:
a screw sleeve for receiving a screw or wrench bit; and
a drill bit sequentially composed of a bit section, a torque-transmitting section and a bit shaft that is adapted to be received in a drill, wherein said torque-transmitting section and said bit section are adapted to be received in said screw sleeve in a form-fitting and torque-fast manner, wherein said bit shaft is provided with three rotational drive surfaces, wherein said rotational drive surfaces are disposed at an angle of 120° relative to one another, and wherein said rotational drive surfaces are adapted for rotational entrainment in a three-jaw chuck of the drill.

15. A multi-purpose tool according to claim 14, wherein said bit shaft is provided with six rotational drive surfaces.

16. A multi-purpose tool according to claim 14, wherein said rotational drive surfaces, when viewed in cross-section, are radially symmetrical relative to one another.

17. A multi-purpose tool according to claim 14, wherein said bit shaft is provided with at least two rotational drive surfaces that extend parallel to one another and across from one another, and wherein such rotational drive surfaces are suitable for being driven by an open end wrench.

18. A multi-purpose tool according to claim 14, wherein three or six of said rotational drive surfaces, which when viewed in cross-section are radially symmetrical relative to one another, are flat.

19. A multi-purpose tool according to claim 14, wherein said rotational drive surfaces, when viewed in cross-section, are concave.

20. A multi-purpose tool according to claim 14, wherein said drill bit is made of a round steel, and wherein outer surfaces of said bit shaft or circular segment surfaces of said bit shaft, which surfaces complement the rotational drive surfaces in a periphery, each form arcs that are congruent to one another.

21. A multi-purpose tool according to claim 14, wherein said rotational drive surfaces each extend in an extension of force-transmitting surfaces of said torque-transmitting section.

22. A multi-purpose tool according to claim 14, wherein a screw or wrench bit receiving means of said screw sleeve has a hexagonal recess, wherein said torque-transmitting section has a hexagonal member, and wherein a diameter of said torque-transmitting section is different than a diameter of said screw or wrench bit receiving means.

23. A multi-purpose tool according to claim 22, wherein the diameter of said torque-transmitting section is greater than the diameter of said screw or wrench bit receiving means.

24. A multi-purpose tool according to claim 14, wherein a diameter of said torque-transmitting section is the same as the diameter of a screw or wrench bit receiving means of said screw sleeve.

25. A multi-purpose tool according to claim 14, wherein said torque-transmitting section is provided with a groove that is configured for receiving an insertion securing means.

26. A multi-purpose tool according to claim 25, wherein said insertion securing means is spring loaded.

27. A multi-purpose tool according to claim 25, wherein said groove of said torque-transmitting section has a concave base.

28. A multi-purpose tool according to claim 25, wherein said groove of said torque-transmitting section has a flat base.
